(19) United States
(12) Patent Application Publication
(10) Pub. No.: US 2023/0213754 A1
(43) Pub. Date: Jul. 6, 2023

(54) LENS MODULE

(71) Applicant: AAC Optics (Nanning) Co., Ltd., Nanning City (CN)

(72) Inventor: Haijun Deng, Shenzhen (CN)

(21) Appl. No.: 17/841,585

(22) Filed: Jun. 15, 2022

(30) Foreign Application Priority Data
Dec. 31, 2021 (CN) 202123437016.3

(51) Int. Cl. G02B 27/00; G02B 7/02

(52) U.S. Cl. CPC G02B 27/0006; G02B 7/026; G02B 5/208

(57) ABSTRACT

The present disclosure provides a lens module including a lens assembly and a lens holder; the lens assembly including a lens barrel and an optical assembly accommodated in the lens barrel; the lens holder including an accommodation portion having an accommodation space; the lens assembly being at least partially accommodated in the accommodation space; the lens holder having a support portion that extends into the accommodation space in a direction of an optical axis of the optical assembly and is disposed on an image side of the lens barrel; the lens module further including a sealing ring disposed on the support portion; and the lens barrel pressing the sealing ring to the support portion to achieve sealing between the lens barrel and the accommodation portion. The present disclosure prevents contaminants such as particles and liquid from entering the lens barrel to contaminate the optical assembly and the optical filter.

### TECHNICAL FIELD

The present disclosure relates to the field of optical imaging devices, in particular to a lens module.

### BACKGROUND

With the development of multimedia technology, digital cameras, video cameras and mobile phones having cameras are more and more popular with consumers.

In the existing technology, a lens module includes a lens assembly and a lens holder, the lens assembly includes a lens barrel and an optical assembly accommodated in the lens barrel, the lens holder includes an accommodation portion having an accommodation space, and the lens assembly is at least partially accommodated in the accommodation space. When the lens barrel is assembled in the accommodation portion, contaminants such as particles and liquids enter from a gap between the lens barrel and the accommodation portion into the lens barrel, which contaminate the optical assembly and a filter and affect imaging quality. In particular, when the lens barrel and the accommodation portion are assembled together by threaded connection, particles may be generated by friction when the threads are locked because the lens barrel and the accommodation portion are both plastic materials, resulting in that the particles easily enter the lens barrel from the gap between the lens barrel and the accommodation portion.

### SUMMARY

The present disclosure aims to provide a lens module with good sealing property, so as to prevent contaminants such as particles and liquid from entering the lens barrel to contaminate the optical assembly and the optical filter.

The technical solutions of the present disclosure are as follows.

A lens module is provided, including a lens assembly and a lens holder; the lens assembly including a lens barrel and an optical assembly accommodated in the lens barrel; the lens holder including an accommodation portion having an accommodation space; the lens assembly being at least partially accommodated in the accommodation space; the lens holder having a support portion that extends into the accommodation space in a direction of an optical axis of the optical assembly and is disposed on an image side of the lens barrel; the lens module further including a sealing ring disposed on the support portion; and the lens barrel pressing the sealing ring to the support portion to achieve sealing between the lens barrel and the accommodation portion.

As an improvement, the support portion is provided with a mounting groove for accommodating the sealing ring.

As an improvement, a depth of the mounting groove is less than a height of the sealing ring.

As an improvement, an inner wall of the accommodation portion is provided with an internal thread, an outer wall of the lens barrel is provided with an external thread, and the internal thread and the external thread are connected to enable the lens barrel to be mounted in the accommodation portion.

As an improvement, an end portion of the accommodation portion adjacent to an object side is provided with a dispensing groove.

As an improvement, the support portion is provided with a through hole, the lens module further comprises a filter mounted on the through hole, and the filter and the optical assembly are on a same optical axis.

As an improvement, a settling groove surrounding the through hole is provided on one side of the support portion facing away from the lens assembly, and the filter is mounted in the settling groove.

As an improvement, one of an adhesive layer and double-sided adhesive is disposed in the settling groove.

As an improvement, the lens holder further includes a mounting portion, and the accommodation portion is fixedly disposed on the mounting portion.

As an improvement, the lens module further includes a driving member disposed on one side of the mounting portion facing away from the accommodation portion.

The present disclosure has the following benefits. The sealing ring is provided, and the sealing ring completely intercepts the external path between the accommodation portion and the lens barrel, which not only avoids the particles generated by friction when the threads of the lens barrel and the accommodation portion are locked from entering the lens barrel to contaminate the optical assembly, but also prevents liquid such as external water vapor from entering the lens barrel, thereby avoiding poor imaging and improving the yield of the lens module. In addition, during assembling, the sealing ring is placed on the support portion, then the lens barrel assembled with the optical assembly is mounted to the accommodation portion, and the lens barrel is mounted in place so that the sealing ring is pressed to the support portion without fixing the sealing ring through dispensing, so that the assembly is more convenient.

### BRIEF DESCRIPTION OF DRAWINGS

FIG. 1 is a schematic cross-sectional structure diagram of a lens module according to a specific embodiment of the present disclosure.

FIG. 2 is a schematic exploded view of the structure shown in FIG. 1.

FIG. 3 is a schematic structural diagram of a lens holder shown in FIG. 1.

### DETAILED DESCRIPTION OF EMBODIMENTS

The following describes the present disclosure further with reference to the accompanying drawings and embodiments.

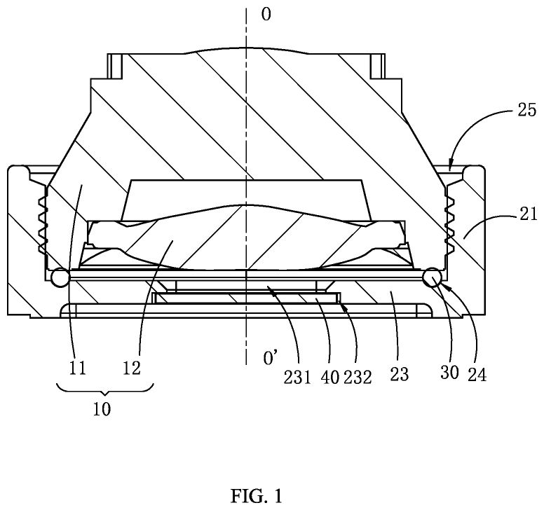

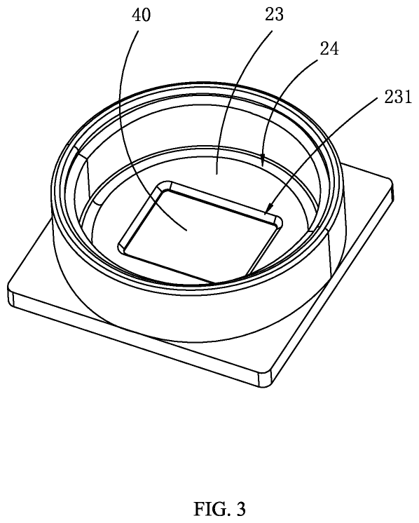

Referring to FIGS. 1 to 3, the present disclosure provides a lens module including a lens assembly 10 and a lens holder 20. The lens assembly 10 includes a lens barrel 11 and an optical assembly 12 accommodated in the lens barrel 11. The lens holder 20 includes an accommodation portion 21 having an accommodation space. The lens assembly 10 is at least partially accommodated in the accommodation space. The lens holder 20 has a support portion 23 that extends into the accommodation space in a direction of an optical axis of the optical assembly 12 and is disposed on an image side of the lens barrel 11. The lens module further includes a sealing ring 30 disposed on the support portion 23. The lens barrel 11 presses the sealing ring 30 to the support portion 23 to achieve sealing between the lens barrel 11 and the accommodation portion 21. By providing the seal ring 30, the seal ring 30 completely intercepts the external path between the accommodation portion 21 and the lens barrel 11, which not only avoids the particles generated by friction when the threads of the lens barrel 11 and the accommodation portion 21 are locked from entering the lens barrel 11 to contaminate the optical assembly 12, but also prevents liquid such as external water vapor from entering the lens barrel 11, thereby avoiding poor imaging and improving the yield of the lens module. In addition, during assembling, the sealing ring 30 is placed on the support portion 23, then the lens barrel 11 assembled with the optical assembly 12 is mounted to the accommodation portion 21, and the lens barrel 11 is mounted in place so that the sealing ring 30 is pressed to the support portion 23 without fixing the sealing ring 30 through dispensing, so that the assembly is more convenient.

Furthermore, in a specific embodiment, the support portion 23 is provided with a mounting groove 24 for accommodating the sealing ring 30, and the mounting groove 24 facilitates positioning and assembly of the sealing ring 30. Specifically, a depth of the mounting groove 24 is less than a height of the sealing ring 30, so that a top end of the sealing ring 30 is still higher than the mounting groove 24 after the sealing ring 30 is mounted in the mounting groove 24. After the lens barrel 11 is mounted in place, the lens barrel 11 presses the sealing ring 30 to deform, so that the sealing ring 30 fills the gap between the lens barrel 11 and the lens holder 20, thereby completely intercepting the external path between the accommodation portion 21 and the lens barrel 11, and effectively protecting the optical assembly 12 in the lens barrel 11 from particles, water stains, liquid, or the like. There is a gap between the sealing ring 30 and the accommodation portion 21, and particles generated by friction when threads of the lens barrel 11 and the accommodation portion 21 are locked are accommodated in the gap to avoid the particles from entering the lens barrel 11 and affecting the imaging quality.

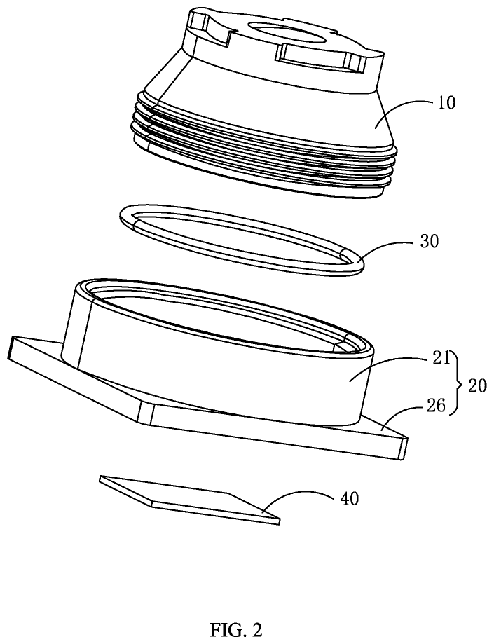

In a specific embodiment, referring to FIG. 1 and FIG. 2, an inner wall of the accommodation portion 21 is provided with an internal thread, and an outer wall of the lens barrel 11 is provided with an external thread. The internal thread and the external thread are connected to enable the lens barrel 11 to be mounted in the accommodation portion 21, and the threaded connection makes the lens assembly 10 more firmly mounted in the lens holder 20, thereby improving mounting stability of the lens assembly 10 in the lens holder 20. Of course, in other embodiments, the accommodation portion 21 may be fixedly connected to the lens holder 20 via other connection structures, e.g., an engagement structure or the like.

In a specific embodiment, referring to FIG. 1, an end portion of the accommodation portion 21 adjacent to an object side is provided with a dispensing groove 25, and dispensing in the dispensing groove 25 is for fixing the lens assembly 10 and the lens holder 20. The lens assembly 10 is further fixed to the lens holder 20 via glue, thereby preventing the lens assembly 10 from loosening to change a focal length of the lens assembly 10 and affect the imaging performance of the lens module.

Referring to FIGS. 1 to 3, the support portion 23 is provided with a through hole 231, and the lens module further includes a filter 40 mounted on the through hole 231. The filter 40 and the optical assembly 12 have the same optical axis 00′. The sealing ring 30 is provided to prevent contaminants such as particles or liquid from entering the lens barrel 11, and to prevent contaminants such as particles or liquid from depositing on surfaces of the optical assembly 12 and the filter 40, thereby affecting the imaging quality. Specifically, in this specific embodiment, the filter 40 is an infrared filter.

Specifically, referring to FIG. 1, a settling groove 232 surrounding the through hole 231 is provided on one side of the support portion 23 facing away from the lens assembly 231, and the filter 40 is mounted in the settling groove 232. The settling groove 232 is provided to facilitate mounting and positioning of the filter 40. An adhesive layer or double-sided adhesive may be disposed in the settling groove 232 to fix the filter 40 in the settling groove 232. The filter 40 is mounted first, and then the filter 40 is fixed by dispensing around the filter 40. Alternatively, the adhesive layer or double-sided adhesive is coated first, and then the filter 40 is mounted.

In a specific embodiment, during assembling, the filter 40 and the lens assembly 10 are assembled respectively, the sealing ring 30 is placed in the mounting groove 24, and then the lens assembly 10 that has been assembled is screwed onto the accommodation portion 21. When the lens assembly 10 is screwed in place, the end portion of the lens barrel 11 presses the sealing ring 30 to the support portion 23, so that the sealing ring 30 completely seals the external path between the lens barrel 11 and the accommodation portion 21, thereby preventing external contaminants such as particles and liquid from entering the lens barrel 11 and contaminating the optical assembly 12 and the filter 40, and avoiding affecting the imaging quality. After the sealing ring 30 is sealed, the lens module that has been assembled is able to be washed with water or the like, and the liquid is unable to enter the inside of the lens barrel 11.

Referring to FIG. 2, the lens holder 20 further includes a mounting portion 26 on which the accommodation portion 21 is fixedly disposed, and the support portion 23 is disposed between the mounting portion 26 and the accommodation portion 21. Specifically, in this embodiment, the accommodation portion 21 is annular, and the mounting portion 26 is square.

The lens module further includes a driving member disposed on one side of the mounting portion 26 facing away from the accommodation portion 21, and the driving member is connected to the mounting portion 26.

The above description merely involves embodiments of the present disclosure, and it should be noted that, for those of ordinary skills in the art, improvements may be made without departing from the inventive concept of the present disclosure, which also belong to the protection scope of the present disclosure.

What is claimed is:

1. A lens module, comprising: a lens assembly and a lens holder; the lens assembly comprising a lens barrel and an optical assembly accommodated in the lens barrel; the lens holder comprising an accommodation portion having an accommodation space; the lens assembly being at least partially accommodated in the accommodation space; the lens holder having a support portion that extends into the accommodation space in a direction of an optical axis of the optical assembly and is disposed on an image side of the lens barrel; the lens module further comprising a sealing ring disposed on the support portion;
and the lens barrel pressing the sealing ring to the support portion to achieve sealing between the lens barrel and the accommodation portion.

2. The lens module according to claim 1, wherein the support portion is provided with a mounting groove for accommodating the sealing ring.

3. The lens module according to claim 2, wherein a depth of the mounting groove is less than a height of the sealing ring.

4. The lens module according to claim 1, wherein an inner wall of the accommodation portion is provided with an internal thread, an outer wall of the lens barrel is provided with an external thread, and the internal thread and the external thread are connected to enable the lens barrel to be mounted in the accommodation portion.

5. The lens module according to claim 2, wherein an inner wall of the accommodation portion is provided with an internal thread, an outer wall of the lens barrel is provided with an external thread, and the internal thread and the external thread are connected to enable the lens barrel to be mounted in the accommodation portion.

6. The lens module according to claim 3, wherein an inner wall of the accommodation portion is provided with an internal thread, an outer wall of the lens barrel is provided with an external thread, and the internal thread and the external thread are connected to enable the lens barrel to be mounted in the accommodation portion.

7. The lens module according to claim 4, wherein an end portion of the accommodation portion adjacent to an object side is provided with a dispensing groove.

8. The lens module according to claim 1, wherein the support portion is provided with a through hole, the lens module further comprises a filter mounted on the through hole, and the filter and the optical assembly have a same optical axis.

9. The lens module according to claim 2, wherein the support portion is provided with a through hole, the lens module further comprises a filter mounted on the through hole, and the filter and the optical assembly have a same optical axis.

10. The lens module according to claim 3, wherein the support portion is provided with a through hole, the lens module further comprises a filter mounted on the through hole, and the filter and the optical assembly have a same optical axis.

11. The lens module according to claim 7, wherein the support portion is provided with a through hole, the lens module further comprises a filter mounted on the through hole, and the filter and the optical assembly have a same optical axis.

12. The lens module according to claim 8, wherein a settling groove surrounding the through hole is provided on one side of the support portion facing away from the lens assembly, and the filter is mounted in the settling groove.

13. The lens module according to claim 12, wherein one of an adhesive layer and double-sided adhesive is disposed in the settling groove.

14. The lens module according to claim 13, wherein the lens holder further comprises a mounting portion, and the accommodation portion is fixedly disposed on the mounting portion.

15. The lens module according to claim 14, further comprising a driving member, wherein the driving member is disposed on one side of the mounting portion facing away from the accommodation portion.
